(19) United States
(12) Patent Application Publication
(10) Pub. No.: US 2015/0361714 A1
(43) Pub. Date: Dec. 17, 2015

(54) DRY CONTAINMENT CURTAIN DEVICE

(71) Applicant: AIRBUS DEFENCE & SPACE SAS, Les Mureaux (FR)

(72) Inventors: Thibault DERODE, Bordeaux (FR); Jean-Marc TUGAYÉ, Bordeaux (FR)

(21) Appl. No.: 14/653,672

(22) PCT Filed: Dec. 18, 2013
(86) PCT No.: PCT/EP2013/077197

§ 371 Date: Aug. 19, 2015

(30) Foreign Application Priority Data
Dec. 19, 2012 (FR) 1262332

(51) Int. Cl. E06B 5/12; E05F 15/72; E06B 5/18

(52) U.S. Cl. CPC E06B 5/12; E06B 5/18; E05F 15/72

(57) ABSTRACT

A confinement mechanism that includes a dry curtain of dimensions greater than the dimensions of a discharge surface to be re-confined, formed by an opening in a building, such as, for example, a door, the curtain deploying in response to a high-pressure wave emitted by an explosion. Advantageously, the curtain is arranged in an envelope and is released from the envelope and deployed in response to the high-pressure wave emitted by the explosion.

### CROSS REFERENCE TO RELATED APPLICATION

This Application is the National Stage of International Application No. PCT/EP2013/077197, having an International Filing Date of 18 Dec. 2013, which designated the United States of America, and which International Application was published under PCT Article 21 (s) as WO Publication 2014/096073 A1, and claims priority from, and the benefit of French Application No. 1262332, filed on 19 Dec. 2012, the disclosures of which are incorporated herein by reference in their entireties.

### BACKGROUND

The disclosed embodiment concerns the domain of confinement of procedures involving high risk of emission of substances that are particularly toxic or radioactive. More generally it concerns the securing of infrastructures that employ high-risk processes when risks of explosion are present (pyrotechnic, chemical . . . ) and risks of emission of toxic chemical substances or radioactive substances. Its objective is to ensure collective protection in industrial and civil safety.

When a procedure presents high risk of explosion with high risk of emission of substances that are particularly toxic or radioactive, it is desirable to ensure confinement of the procedure in an infrastructure such as a building guarding against the dissemination of these substances. As a function of the quantity of energy released in the event of an explosion, it may be illusory, or at least prohibitive, to create a building that is completely impervious to the explosion.

In the case of a non-impervious building, it is possible to limit the quantity of effluents issued by defining a surface for discharge that will make it possible to preserve the integrity of the building, this surface for discharge functioning as a discharge valve.

In the context of the presently disclosed embodiment we operate in a configuration in which the building resists the explosion and does not collapse. Even if some of the toxic or radioactive substance is emitted at the moment of the explosion onto the discharge surface in the building, an immediate confinement of the building at the level of the discharge surface is very beneficial and makes it possible to strongly limit, or even prevent, gaseous or particulate emissions after the explosion, and thus to limit the risk of harmful effects on the employees and the neighboring populations.

Confinement solutions for collective protection in the domain of industrial risk are at varying degrees of development. In case of fire, confinement by a curtain of water set off upon detection of the fire, and fireguard compartmentalization are currently widely used, and numerous mechanisms created using this principle are available. The creation of confinement for gaseous or particulate emissions is well known for installations that do not have a risk of explosion.

For completely confined zones, fire-fighting technologies using a water curtain are widely used. The disadvantages of confinement by water curtain are its decreasing effectiveness over time, and its limited autonomy requiring a continuous water supply. Confinement technology also exists in the form of an automatic or remote-controlled movable door, but the main problem is guaranteeing that the door is operational after the effects of the explosion, in particular the shock wave, impact by fragments, or the deformation of the building. Moreover, these doors require a non-trivial amount of time to operate.

### SUMMARY

The presently disclosed embodiment aims to provide a confinement solution with very short response time, with high effectiveness and impermeability, with high reliability and resistance to impacts linked to the initial explosion: shock wave, fragments, deformation of the building. To do this, the disclosed embodiment proposes to use a dry curtain, oversized in relation to the dimensions of the surface to confine, designed to function autonomously, and which is protected from the initial explosion.

More particularly the presently disclosed embodiment proposes a confinement mechanism in a building comprising a discharge surface to be confined, formed by an opening in the building, such as a door, for example, characterized by the fact that it comprises a dry curtain chosen to be of larger dimensions than the said opening, the said curtain being positioned and configured in such a way that it will deploy by free fall in response to a high-pressure wave emitted by an explosion.

According to a preferred aspect of the mechanism, the latter consists of an envelope in which the curtain is placed, the mechanism being made such that the envelope is designed to release and deploy the curtain in response to the high-pressure wave emitted by the explosion. The mechanism consists advantageously, moreover, of a lintel in the frame of the opening, and the dry curtain is placed on an external face of the lintel in relation to the interior of the building where the explosion is likely to occur. The dry curtain is preferably placed on an external face of a lintel in the frame of the opening in the building, the explosion being likely to occur in the interior of the building.

The material of the curtain is advantageously composed of a web woven of a technical thread coated on both faces with one or more layers of a material suitable for ensuring the impermeability of the curtain and chemically compatible with the gas emitted during the explosion. The curtain is advantageously provided with horizontal stiffeners. The curtain preferably comprises a bar of ballast on the lower edge to aid in deployment of the curtain. The bar of ballast is advantageously provided with a joint on the underside of the curtain, the said joint being adapted to ensure the impermeability of the curtain at the lower edge of the curtain. Advantageously the confinement mechanism comprises, moreover, a system for extraction of gas making it possible to lower the pressure in the building after the explosion, so as to flatten the curtain against the frame of the opening.

According to a first aspect of the disclosed embodiment, the curtain is folded in a case comprising a lower panel designed to be torn off, which in response to the high-pressure wave of an explosion is adapted to eject the case and to free the curtain, which is likely to deploy solely under the force of gravity.

According to a second aspect of the disclosed embodiment, the mechanism comprises retractable pneumatic jacks to release the curtain, comprises pyrotechnic igniters to activate the jacks, and comprises an explosion detection network capable of generating an electric signal to activate the igniters.

According to a third aspect of the disclosed embodiment, the mechanism comprises retractable pneumatic jacks to release the curtain, and an explosion detection network capable of generating an electric signal to activate the jacks. Advantageously the mechanism comprises a flexible envelope in which the curtain is coiled or rolled, the envelope being held back by the jacks by means of eyelets holding the flexible envelope before the retraction of the jacks. In this case, the curtain deploys preferably following the release of the envelope following the retraction of the jacks. The mechanism preferably comprises a secure electric supply.

### BRIEF DESCRIPTION OF THE DRAWINGS

Other characteristics and advantages of the disclosed embodiment will be apparent upon reading the description following the non-restrictive examples, accompanied by drawings that represent:

FIGS. 1A and 1B are cutaway side views of a mechanism according to a first aspect of the disclosed embodiment;

FIGS. 2A and 2B are cutaway side views of a mechanism according to a second aspect of the disclosed embodiment;

FIG. 3 is a detailed view of a mechanism according to a third aspect of the disclosed embodiment.

### DETAILED DESCRIPTION

The disclosed embodiment allows for a mechanism comprising a dry curtain arranged in such a way that it can confine or re-confine a discharge zone, for example a door, in response to an explosion. The mechanism of the disclosed embodiment is designed to be rapidly deployable and unlikely to be knocked out of service by an explosion.

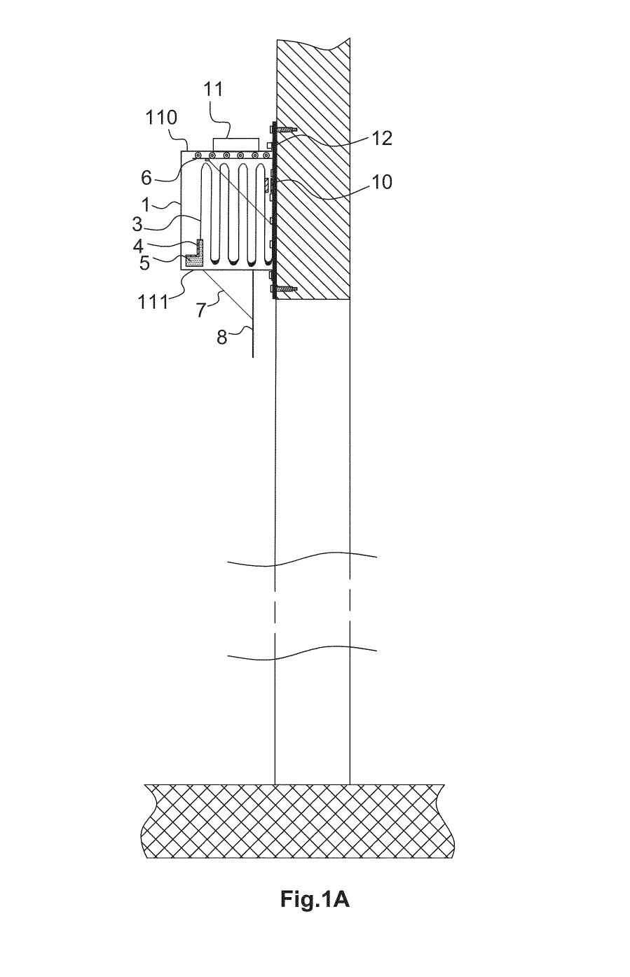

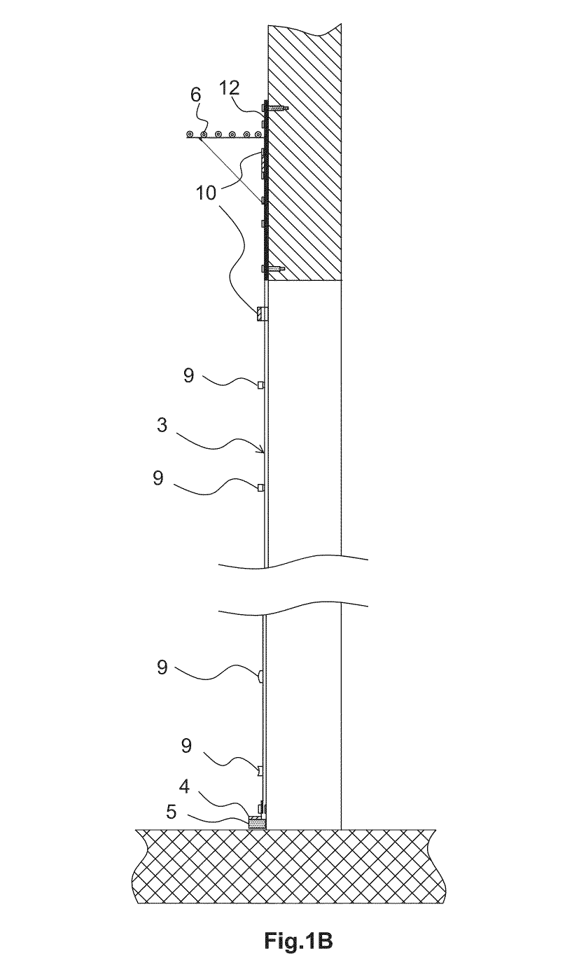

The aspect described in FIGS. 1A and 1B respectively before deployment and after deployment of the dry curtain correspond to a first aspect of the disclosed embodiment for which the curtain is stored in an immovable case.

According to FIG. 1A, the curtain 3 is placed in a case 1, which is itself placed on the external face of the lintel of the door to be re-confined. The mechanism placed on the exterior of the building to be re-confined is thus protected by the lintel from projectiles issuing from an explosion. The curtain is attached to a sheet-metal interface 12, which is itself attached to the wall above the door. The sheet metal is of slight thickness, which makes it possible to obtain a relatively flexible interface, able to withstand deformations of the lintel under the force of the high-pressure waves of an explosion.

The material of the curtain is chosen as a function of the necessary chemical resistance, but is typically made of a woven fabric covered on the two faces with one or more layers of one or more impervious materials, the fabric being, moreover, provided with horizontal stiffeners distributed from top to bottom of the curtain.

The curtain comprises a bar of ballast on the lower edge 4, which is provided with a joint 5, for example a joint made of foam, EPDM whose function is in particular to compensate for differences in height of the floor or of the curtain, or the parallelism between the curtain and the floor, and which makes it possible to ensure the impermeability of the curtain at its lower edge, the height of the deployed curtain being slightly greater, for example on the order of 1 cm, than the distance between the upper thread of the curtain and the floor.

The building may, moreover, be provided with a gas extraction system, not shown, this system making it possible to de-pressurize the area after the explosion and therefore to ensure better impermeability at the edges of the curtain, by flattening it against the frame of the opening.

The mechanism comprises a panel designed to tear 8 in line of sight from the center of the explosion. This panel attached to the case 1, under the action of the high-pressure wave of an explosion, ejects the case and releases the curtain, which then deploys and falls solely with the force of gravity, due to its weight and the weight of the bar of ballast on the lower edge of the curtain.

According to FIG. 1A, the curtain is arranged in pleats in a case of steel sheets. An upper wall 110 of the case is positioned on a support 6 linked to an interface plaque by mounting connectors 2, and the case 1 rests simply on the support 6.

Two lifting interfaces 11 soldered to the case facilitate easy mounting of the ensemble with the help of a forklift. The support 6 of the case is composed of two braces placed at the edges of the curtain and not impeding its deployment, on which steel bars rest, which extend above the curtain and support the case 1.

Thus the supports 6 and the bars that extend between them are received in the interior of the case. This design, according to which the upper face 110 of the case rests on the bars, makes it possible, when the case is in the process of ejecting, that the force of the high pressure applies to the interior of the case and not to the support, to allow the correct ejection of the case.

The curtain, for its part, rests on the lower face 111 of the case. The ejection of the case is caused by the force of the high-pressure wave on the tearable panel 8, which is positioned under the lintel. The transmitted force causes the rotation and then the ejection of the case and the release of the curtain 3. The installation of struts 7 makes it possible to transmit the tearing force to the ensemble of the case, and not to deform only the tearable panel 8.

When the case is sufficiently obliterated, the curtain falls and deploys under its own weight and that of the bar of ballast 4, and flattens against the frame around the opening. Attachments to brake the fall of the curtain are realized here by mechanical adhesives 10 such as those known under the brand Velcro, which are linked to the last fold, making it possible to slow the bar of ballast 4 at the end of its fall and prevent it from being damaged.

This bar of ballast 4 comprises a compensating joint made of foam 5, which makes it possible to ensure imperviousness at the lower edge of the curtain. Stiffeners 9 are arranged at regular intervals along the curtain 3.

According to the example, the stiffeners are made of a section of metal bar. To position this section, a strip of cloth is sewed onto the fabric of the curtain, for example leaving a longitudinal opening, and the section is inserted into the opening between the two pieces of cloth. The length of the metal section is such that the section rests on the lintels of the door in such a way that it holds back the curtain, but the metal sections are shorter than the width of the curtain so that strips of the curtain beyond the metal sections keep their flexibility and can form a joint with the wall. This makes it possible to determine that the curtain is free at its lateral sides, and extends beyond the edges of the frame.

Once in place, the curtain requires no inputs of energy or other consumables, thus it can ensure its operation without intervention or maintenance. For a door of 4 m in width, considering that the curtain will extend 50 cm on either side of the frame, and considering pleats of approximately 0.5 m, a case in the shape of a parallelepiped of approximately 0.6×0.5×0.4 m is required. The case may, for example, be made of 2 mm sheet metal and have a tearable panel approximately 0.3 m high. The mass of the case is therefore about 150 kg.

A weak explosion of, for example, 40 g of TNT, located on the floor at 5 m from the door, will generate a peak of dynamic high pressure of about 7,000 Pa [Pascal, unit of pressure] on the tearable panel, which leads to a peak of dynamic force of 5,600 N, quite sufficient to ensure the tearing of the case. The time taken to deploy the curtain can be estimated at less than one second since its deployment corresponds approximately to a free fall from a height of 4 m. A free fall is involved and there is no guide on the sides of the opening, as such guides would only slow the fall of the curtain or even block it in the event of deformation following the explosion.

It is to be noted that the case may be divided into several parts along the width of the door, so that a deformation of the wall following an explosion does not block the descent system of the curtain.

FIG. 1B represents the curtain deployed along the door frame, with the compensating joint 5 resting on the floor.

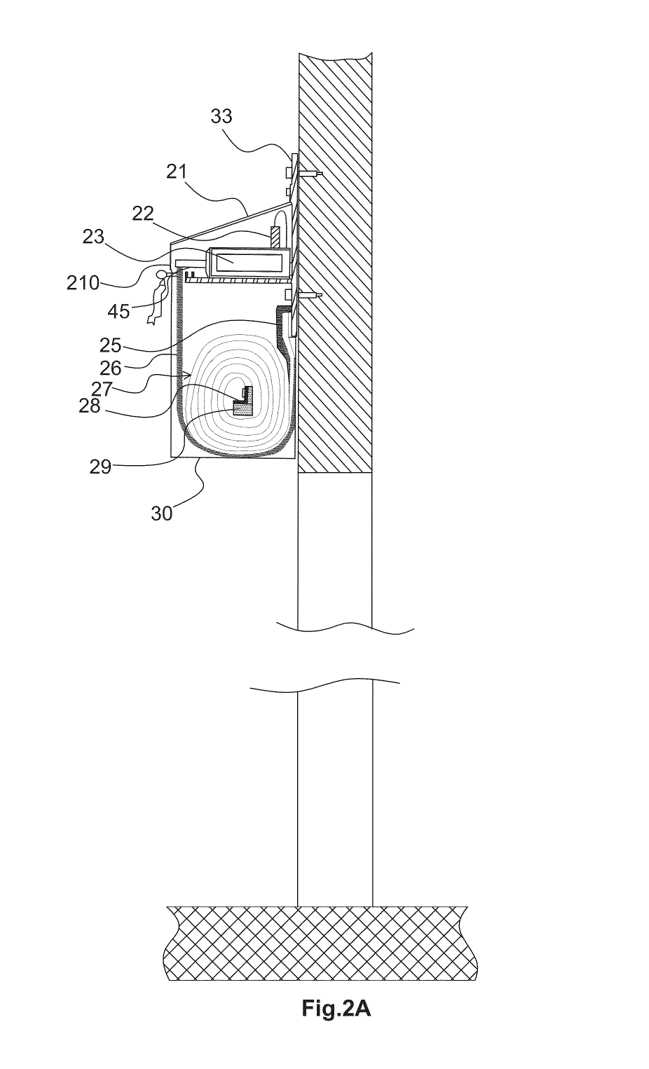

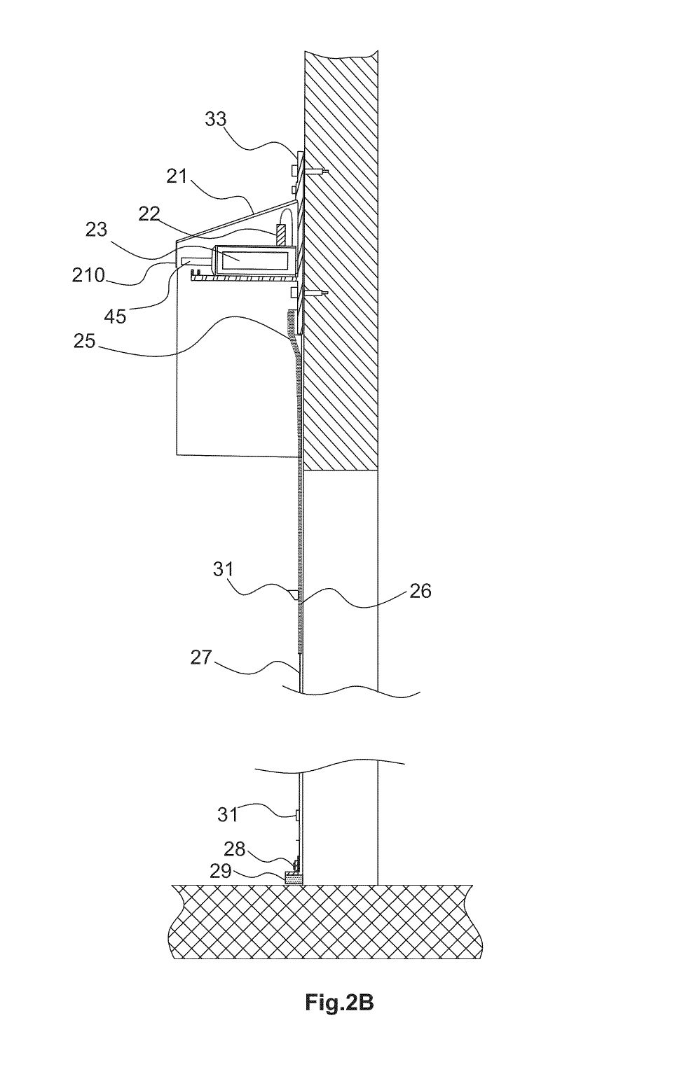

The aspects in FIGS. 2A and 2B correspond to a guided mechanism that uses a dry curtain released by retractable jacks.

According to this aspect, the jacks are retractable pneumatic jacks. These retractable jacks are activated by pyrotechnic igniters, which are themselves ignited by an electric signal coming from an explosion-detection network. This explosion-detection network may be of the type described in U.S. Pat. No. 6,031,462 A1. The mechanism in this aspect is an autonomous mechanism, insofar as it uses a secure electric supply, for example a sector supply assisted by batteries.

According to FIG. 2A, the curtain 27 is rolled up and held in a flexible storage envelope 26, one part of which is attached to the principal structure 33, and the other part of which is suspended from two retractable jacks 23, by means of metal support buckles that slide along the shank 45 of each jack 23. The principal structure 33 is itself interdependent with the lintel for local protection, and the jacks 23 are interdependent with the principal structure 33. Each jack 23, typically a double-action type jack mounted in retracted action, is activated by a pyrotechnic igniter 22. The two igniters 22 are activated by a high-pressure detection network with sensor and controller of a known type, not described here.

The igniters comprise an electric insulator made of a pyrotechnic mixture. When a current of sufficient intensity circulates through the insulator for a given time, the pyrotechnic mixture burns, which generates a gas, activating the pneumatic jack. The jacks 23, the igniters 22 and the frame 27 are protected from bad weather, dust and mechanical impacts by a cover 21.

The cover 21 is attached to the principal structure 33 and comprises a vertical return 210 which limits the motion of the metal buckles or eyelets on the shanks 45 of each jack 23. This makes it possible to avoid a precipitous fall of the curtain in the event that the metal buckles come off the shanks of the jacks. Furthermore, a pin 24 can be put in place during assembly/disassembly or maintenance of the ensemble, in order to prevent a precipitate fall of the curtain 27. Lateral panels 30 protect the curtain from lateral mechanical impacts.

After the detection of an explosion, the electric signal emitted by the detection network ignites the two igniters 22, and then causes the retraction of the axles of the jacks 23. This movement of the axles releases the metal buckles of the storage envelope 26, which tears and allows the passage of the curtain 27, which deploys under the action of gravity brought on by its weight and the weight of the bar of ballast 28. Here also no lateral guide is provided, and the curtain simply falls along the opening. The bar of ballast 28 here as well comprises a compensation joint of foam 29, which makes it possible to ensure impermeability at the lower edge of the curtain.

Stiffeners 31 are arranged at regular intervals along the curtain 27 to ensure the rigidity of the curtain under the force of pressure. The impermeability of the curtain against the frame of the opening to be protected is also enhanced by a sheet of plywood 25 which covers the curtain 27 and the storage envelope 26, compensating for the thickness of the principal structure 33.

In the present aspect and in the preceding aspect, the curtain 27 can in particular be formed of a technical fabric coated with a suitable material to ensure the impermeability of the curtain. The material coating the curtain must be a material that is chemically compatible with the gases emitted by the explosion, i.e. a material that does not degrade in contact with these gases.

The material is, for example, an NBC (nuclear, biological, chemical) approved material, or even NRBC (nuclear, radiation, bacteriological, chemical). One example can be the material supplied by the Saint-Gobain Company under the Coretech Shelterguard 1450 brand. The fabric of the curtain may in particular be made of aramid fibers.

As with the first aspect, the time taken to deploy the curtain may be estimated at less than one second. Once in place, as represented in FIGS. 1B and 2B, the curtain can ensure its function without requiring energy input and without consuming water or other fluids, which makes it possible to envisage implementing other actions to secure the building without being pressed for time.

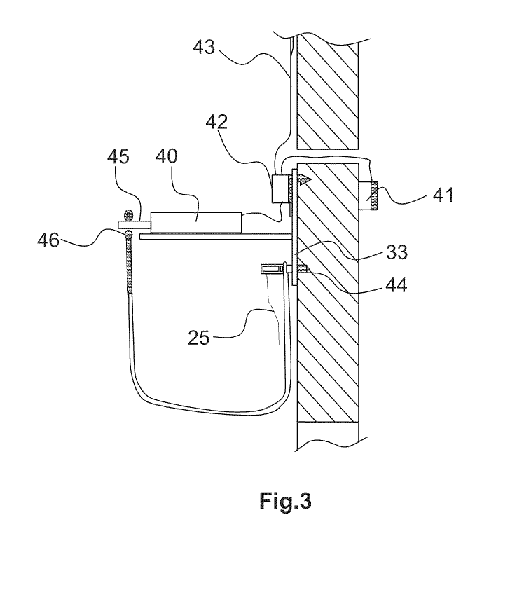

In an aspect according to FIG. 3, the jacks 40 are electric jacks directly commanded by 15 an electric signal coming from an explosion detection network.

According to the aspect, this network comprises a sensor 41, according to the aspect placed at the level of the mechanism of the disclosed embodiment or on the opposite side of the principal structure, and an electronic detector box 42 connected to a source of electricity by a cable 43. The electronic box 42 may be provided with a built-in backup battery. It can be placed in proximity to the curtain as represented, but can also be positioned in an electric supply room of large dimensions gathering together several functions and located in an accessory building to the trial building.

Similarly, the sensor 41 can be positioned elsewhere than in proximity to the curtain, its position should in particular be chosen for good detection of the explosion.

FIG. 3 makes it possible, among other things, to better visualize the flexible storage envelope 26 similar to that in the mechanism in FIG. 2A, and which is, for example, made from a rectangular piece of cloth attached, on one edge, by anchors 44 in the wall and held back by means of the door structure 33, and comprising the eyelets 46 passed over the shanks 45 of the jacks 40 on a second edge opposite the first edge.

As in the preceding aspect, the sheet of plywood 25 enhances the impermeability at the top of the curtain against the door frame by flattening the curtain and the storage envelope and compensating for the thickness of the door structure 33.

The disclosed embodiment defined by the claims is not limited to the aspects represented, and in particular it applies to other openings than doors. Moreover, the mechanism with jacks may act to release a trap instead of the envelope 26.

What is claimed is:

1. A confinement mechanism for confinement of a building, comprising a discharge surface to be re-confined formed by an opening in the building, as for example a door, characterized in that it comprises a curtain chosen to have dimensions greater than the dimensions of the said opening, the said curtain being positioned and configured so as to deploy by free fall in response to a high-pressure wave emitted by an explosion.

2. The confinement mechanism for confinement of a building according to claim 1, wherein the curtain is arranged in an envelope appropriate to release and deploy the curtain in response to the high-pressure wave emitted by the explosion.

3. The confinement mechanism for confinement of a building according to claim 1, further comprising a lintel framing the opening, wherein the dry curtain is placed on an external face of the lintel in relation to the interior of the building where the explosion is likely to occur.

4. The confinement mechanism for confinement of a building according to claim 1, wherein the material of the curtain is composed of a woven fabric made of technical fiber coated on the two faces by one or more layers of a material suitable to ensure the impermeability of the curtain, and chemically compatible with the gases emitted during the explosion.

5. The confinement mechanism for confinement of a building according to claim 4, wherein the curtain is provided with horizontal stiffeners.

6. The confinement mechanism for confinement of a building according to claim 4, wherein the curtain comprises a bar of ballast on the lower edge to aid in the deployment of the curtain.

7. The confinement mechanism for confinement of a building according to claim 6, wherein the bar of ballast is provided with a joint at the lower edge of the curtain, said joint being appropriate to ensure the impermeability of the curtain at the lower edge of the curtain.

8. The confinement mechanism of a building according to claim 1, comprising a system for extraction of gasses, making it possible to lower the pressure in the building after the explosion, in order to flatten the curtain against the frame of the opening.

9. The confinement mechanism of a building according to claim 1, for wherein the curtain is folded in a case, having a lower panel that can be torn away that, under the force of the high-pressure wave, is appropriate to eject the case and release the curtain that is likely to deploy solely under the force of gravity.

10. The confinement mechanism of a building according to claims 1, comprising retractable pneumatic jacks for releasing the curtain, further comprising pyrotechnic igniters to activate the jacks and an explosion detection network able to generate an electric signal to activate the igniters.

11. The confinement mechanism of a building according to claim 1, comprising retractable electric jacks for releasing the curtain, and an explosion detection network able to generate an electric signal to activate the jacks.

12. The confinement mechanism of a building according to claim 10, comprising a flexible envelope wherein the curtain is coiled or rolled, and wherein an envelope is held back by the jacks by means of eyelets holding back the flexible envelope before retraction of the jacks.

13. The confinement mechanism of a building according to claim 12, wherein the curtain is configured to deploy following the release of the envelope following the retraction of the jacks.

14. The confinement mechanism of a building according to claim 10 comprising a secure electric supply.

15. The confinement mechanism of a building according to claim 5, wherein the length of the metal sections is defined in such a way that they are supported by the sides of the opening, and that they are shorter than the width of the curtain.

16. The confinement mechanism of a building according to claim 5, wherein the curtain is free at its lateral sides and extends beyond the lateral edges of the frame.
